(19) United States
(12) Patent Application Publication
(10) Pub. No.: US 2026/0156566 A1
(43) Pub. Date: Jun. 4, 2026

(54) ENERGY SAVING AND EFFICIENT ROUTING METHOD FOR UNDERWATER SENSOR NETWORK

(71) Applicant: JIANGSU UNIVERSITY OF SCIENCE AND TECHNOLOGY, Jiangsu (CN)

(72) Inventors: Biao WANG, Jiangsu (CN); Haobo ZHANG, Jiangsu (CN); Yunan ZHU, Jiangsu (CN); Youwen ZHANG, Jiangsu (CN); Tao FANG, Jiangsu (CN); Wu WANG, Jiangsu (CN)

(73) Assignee: JIANGSU UNIVERSITY OF SCIENCE AND TECHNOLOGY, Jiangsu (CN)

(21) Appl. No.: 18/979,516

(22) Filed: Dec. 12, 2024

Related U.S. Application Data
(63) Continuation of application No. PCT/CN2023/125416, filed on Oct. 19, 2023.

(30) Foreign Application Priority Data
Jul. 12, 2023 (CN) 202310852714.4

(51) Int. Cl. H04W 52/02; H04B 13/02; H04W 84/18

(52) U.S. Cl. CPC H04W 52/0203; H04B 13/02; H04W 84/18

(57) ABSTRACT

Disclosed is an energy-balanced and efficient routing method that adopts a power control mechanism to reduce energy consumption, and the method involves two phases: routing establishment phase and data forwarding phase. In the routing establishment phase, a sink node broadcasts a beacon packet at a maximum transmission power to establish an initial path, and a receiving node updates the routing table according to beacon information and forwards the beacon packet. In the data forwarding phase, the present disclosure provides a new forwarding factor, which gives comprehensive consideration to energy efficiency and energy balance, selects a node with high energy efficiency and sufficient energy an optimal next-hop node, thereby extending the life cycle of the network. Further provided is a data protection and network recovery mechanism. Topological changes of the network, data forwarding failures and other problems caused by node movement can be solved.

### CROSS-REFERENCE TO RELATED APPLICATION

This application is a continuation of international application of PCT patent application PCT/CN2023/125416, filed on Oct. 19, 2023, which claims the priority benefit of China application no. 202310852714.4 filed on Jul. 12, 2023. The entirety of each of the above-mentioned patent applications is hereby incorporated by reference herein and made a part of this specification.

### TECHNICAL FIELD

The present disclosure relates to the field of sensor network technology, and particularly relates to an energy saving and efficient routing method for an underwater sensor network.

### BACKGROUND

As routing in an underwater wireless sensor network enables the transmission of information and data between underwater nodes, it is crucial for realizing underwater application. However, routing in underwater wireless sensor network differs greatly from that in a wireless sensor network applied on land, and faces more challenges. On the one hand, the underwater network has rigorous requirements for energy consumption between nodes, because the underwater nodes cannot replenish energy by themselves, and their stored energy is limited. When being overused, one node will become ineffective due to premature energy exhaustion, which could lead to network partition and accordingly affects normal operation of the network. Therefore, when designing a routing protocol, it is essential to ensure that the energy of all nodes can be reduced in a synchronized manner. On the other hand, an underwater network structure is dynamic to some extent, and nodes thereof will move within a certain ran due to the influence of water flow, resulting in dynamic changes in the network structure. Therefore, the designed routing protocol should adapt to topological changes of the network. The above characteristics bring forward more rigorous requirements for routing, in which case, it is necessary to design a routing method specifically tailored to the underwater network according to the characteristics.

### SUMMARY

An objective of the present disclosure is to reduce energy consumption of an underwater network, extend the life cycle of the network, and achieve efficient forwarding of a data packet at each hop.

Technical solution: in order to achieve the above objective, the present disclosure provides an energy saving and efficient routing method for an underwater sensor network, based on a depth. In the present disclosure, all data packets and control packets contain information such as a transmission power, residual energy, and depth of a sending node. In a routing establishment phase, a sink node broadcasts a beacon packet at a maximum transmission power to establish an initial path, When receiving the beacon packet from the previous-hop node, a relay node calculates a power level required for the previous-hop node by measuring a received signal strength, then calculates a forwarding factor for the previous-hop node according to information in the packet and the power level, and stores the same to a routing table, and finally the relay node will update the information in the beacon packet and broadcast at the maximum transmission power; and in order to avoid repeated transmission of the data packet by nodes, each node only sends a beacon packet only once in a period of time. In a data transmission phase, the node sets a neighbor node with a maximum forwarding factor in the routing table as an optimal next-hop node, and forwards the data to the next-hop node. In order to solve the node mobility problem, the low channel utilization and high energy consumption caused by frequent sending of a beacon packet, the present disclosure provides an implicit routing update mechanism, that is, the node will monitor all data packets and control packets within a communication range thereof, and complete the updating and maintenance of the routing according to the signal strength and information in the packet. In order to solve the data forwarding failures and routing failures caused by node mobility, the present disclosure provides an integrated strategy of local-overall combination, specifically including two parallel mechanisms, that is, a local recovery mechanism and an overall recovery mechanism. When the data packet forwarding fails, the local recovery mechanism will be triggered, the node will send a probe packet to rebuild a routing table, and retransmit the data according to the routing table. When the sink node monitors that a packet arrival rate is lower than a threshold, the local recovery mechanism will be triggered, and the sink node will send a beacon packet to complete the routing reconstruction of the entire network. Specific steps of the method in the present disclosure are as follows:

Step 1: a sink node on a water surface broadcasts a beacon packet at a maximum transmission power to perform routing establishment. An initial path is established by broadcasting the beacon packet at the maximum transmission power, the data transmission along the initial path receives a comprehensive optimization of energy efficiency and energy distribution with the help of the forwarding factor, and the receiving node determines whether the node sending the beacon packet meets the conditions for becoming the next hop, the beacon packet will be discarded directly when the conditions are not met, otherwise, an optimal transmission power from the current sending node to a next sending node will be calculated according to the transmission power and received signal strength recorded in the packet, the forwarding factor will be calculated in combination with residual energy information of the current sending node, and record the same into the routing table, a neighbor node with a maximum forwarding factor is an optimal next-hop node, and the current sending node then generates a beacon packet and broadcasts the same. In order to prevent repeated transmission, a node sends only one beacon packet in a period of time.

Step 2: the network enters a data forwarding phase upon completion of the routing establishment. When receiving the data packet, the relay node first executes the implicit routing update mechanism, updates the routing table according to information in the data packet, and then forwards the data packet to the neighbor node with the maximum forwarding factor.

Step 3: when the sink node receives the data packet, it indicates that the data forwarding succeeds; the sink node then filters out a duplicate packet and calculates the packet arrival rate; and when the packet arrival rate is lower than the threshold, an overall recovery mechanism is triggered, and the sink node rebuilds a network routing.

When the data packet forwarding fails, the following steps are continuously performed:

Step 4: after the node forwards the data, neither a next-hop node forwarding the data packet is monitored nor an ACK packet from the next-hop node is received in a period of time (T), it is determined that the data forwarding fails, in which case, the node needs to execute the local recovery mechanism.

Step 5: when the local recovery mechanism fails to rebuild the network routing, the node will be determined to be a void node, and the node will then broadcast a void notification packet to notify the previous-hop node to remove itself from a neighbor list.

Further, calculating steps of the forwarding factor mentioned in Step 1 are as follows: assuming the current node as Node A and the neighbor node as Node B, the forwarding factor between Node A and Node B is specifically calculated as follows:
when Node A receives the packet (such as, a beacon packet) sent by Node B, assuming received signal strength of the packet as Rss, then:

$$Rss = 10 log {P}_{0} \qquad ( 1.1 )$$

where P₀ is a signal power received by Node A. Assuming that a power of Node B when sending the beacon packet is Pₜ, path loss L_{AB} between Node A and Node B can be expressed as:

$${L}_{AB} = \frac{{P}_{t}}{{P}_{0}} \qquad ( 1.2 )$$

Then an optimal transmission power P_{optAB} from Node A to Node B is:

$${P}_{optAB} = {L}_{AB} {P}_{th} \qquad ( 1.3 )$$

where Pₜₕ represents a signal reception threshold in watts, and a power level P_{ABL} required for communication between Node A and Node B is determined by P_{optAB}, that is:

$${P}_{ABL} ← {P}_{optAB} \qquad ( 1.4 )$$

According to the above formula, when Node A sends a data packet to Node B, energy consumed E_{AB} is:

$${E}_{AB} = {P}_{opt} {t}_{send} \qquad ( 1.5 )$$

where t_{send} represents transmission time, it should be noted that Node B also consumes energy when receiving the data packet, but since a node reception power is much lower than the transmission power, the energy consumption at Node B is ignored when the forwarding factor is calculated.

Assuming normalized residual energy efficiency of Node A and normalized energy efficiency between Node A and Node B as Eᵣₑ and E_{ηAB}, respectively, then a forwarding factor from Node A to Node B is:

$$\begin{matrix}{f}_{AB} = {p}_{B} ( α {E}_{η AB} + β {E}_{re} ) & {E}_{re} , {E}_{η AB} ∈\end{matrix} ( 0 , 1 ] \qquad ( 1.6 )$$

where P_{B} is a forwarding success rate of a data packet of Node B, with an initial value of 1; α and β are system parameters, meeting α+β=1, in theory, the larger α is, the better the routing effects become in energy saving; and on the contrary, the smaller α is, normalized energy efficiency between Node A and Node B of the routing becomes better. The energy efficiency E_{ηAB} can be calculated by the following formula:

$${E}_{η AB} = \frac{Δ {d}_{AB}}{{E}_{AB}} \qquad ( 1.7 )$$

where Δd_{AB} is a depth difference between Node A and Node B.

The forwarding factor is used to select the relay node, which plays a crucial role in enhancing energy-efficient data transmission. However, when a farther distance between a source node and the relay node is, the more the energy consumption of transmission will become. On the contrary, when the distance becomes shortened, a number of hops will increase, which will also lead to higher end-to-end latency. Therefore, in order to limit a number of data packet hops and balance the network energy consumption and the end-to-end latency, a depth difference threshold is assumed to be dₜₕ, only when a depth difference between the node and the neighbor node is greater than the depth difference threshold, the node will calculate the forwarding factor between the node and the neighbor node, and store the same in the neighbor list. The depth difference threshold dₜₕ is calculated according to the following formula:

$${d}_{th} = γ R \qquad ( 1.8 )$$

where R is a maximum communication radius, and γ is a threshold coefficient, with a value ranging from 0 to 1.

Further, the overall recovery mechanism and the local recovery mechanism mentioned in Steps 3 and 4 are two parallel mechanisms of an integrated strategy of local-overall combination, with specific operations being as follows: for the local recovery mechanism, the node sends a probe packet at the maximum transmission power and sets waiting time (T) when the sending fails; after receiving the probe packet, a next-hop node that meets the next-hop node conditions responds with a probe response packet at the maximum transmission power; upon reception of the probe response packet, the node will calculate the forwarding factor and update the routing table; and after the waiting time (T) expires, the node will select the neighbor node with the maximum forwarding factor in the routing table as the next-hop node and forward the data packet. For the global recovery mechanism, all the sink nodes share the received data packets, record a total number of non-duplicate packets received within the T, and compare the value with a total number of data packets sent by the source node within the same period of time; and when a ratio is less than a preset threshold, the overall recovery mechanism will be triggered, and the sink node then sends a beacon packet to rebuild the network routing.

Beneficial effects: the present disclosure provides an energy saving and efficient routing method for an underwater sensor network. In terms of power control, the present disclosure estimates path loss based on the received signal strength and adjusts the transmission power accordingly. In terms of selecting a next-hop node, the forwarding factor gives comprehensive consideration to energy efficiency and energy balance according to transmission power, depth difference, residual energy, and other information, and then selects a node with high energy efficiency and relatively sufficient energy as the optimal next-hop node. Simulation results indicate that compared with the existing typical routing methods, the present disclosure exhibits a longer network lifespan and lower energy consumption. However, power control and data protection mechanism of the present disclosure increases a certain end-to-end delay, therefore, the present disclosure is suitable for systems that are insensitive to delays and have high requirements for network lifespan, such as underwater pollution monitoring, equipment monitoring (with low requirements for real-time performance) in long-term running application.

### BRIEF DESCRIPTION OF THE DRAWINGS

FIG. 1 is a flow chart of forwarding a data packet by an energy saving and efficient routing method for an underwater sensor network according to the present disclosure.

FIG. 2 is a schematic diagram of implementation of routing establishment according to the present disclosure.

FIG. 3 is a schematic diagram of implementation of data forwarding according to the present disclosure.

FIG. 4 is a schematic diagram of implementation of local recovery according to the present disclosure.

FIG. 5 is a chart of energy consumption comparison between a method of the present disclosure and other routing methods.

### DETAILED DESCRIPTIONS OF THE EMBODIMENTS

The technical solution of the present disclosure will be further described below with reference to the accompanying drawings.

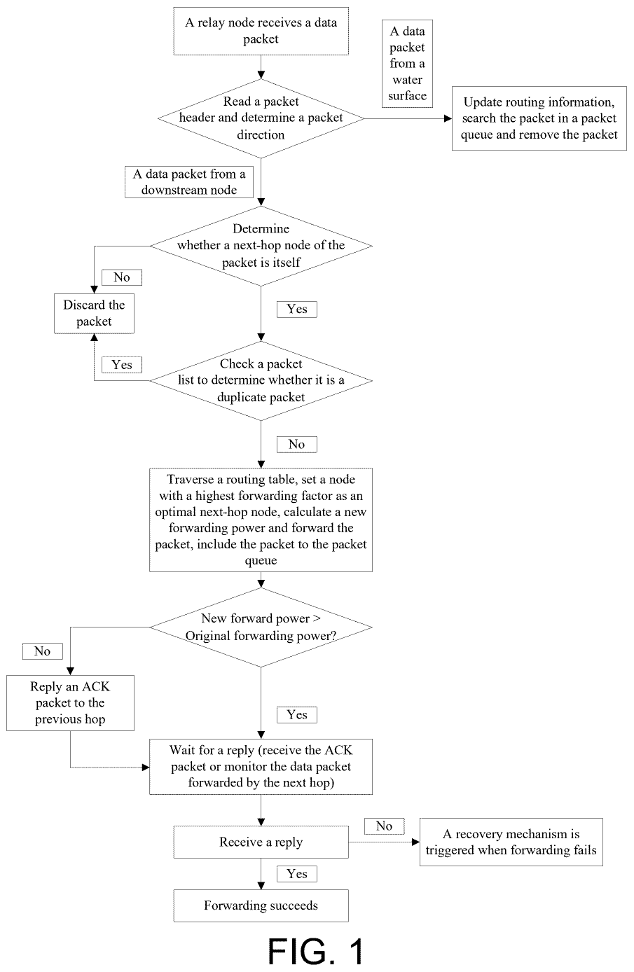

As shown in FIG. 1, the present disclosure provides an energy saving and efficient routing method for an underwater sensor network. When a data packet comes from a water surface, it means that a data packet forwarded by a next-hop node has been monitored, and the node updates routing table information, then searches for and clears the packet from a packet list; and when a data packet comes from a downstream node, the packet will be forwarded or discarded according to the packet header information. When current forwarding power is less than that of a previous hop, it means that the previous hop cannot monitor data packet forwarded by current node, therefore, it is necessary to reply an ACK packet to inform that data forwarding of the previous hop is successful; and on the contrary, when current forwarding power is greater than or equal to that of a previous hop, it means that the previous hop can monitor data packet forwarding by current node, thereby confirming that the data packet has been successfully forwarded, therefore, it is unnecessary to reply to the ACK packet.

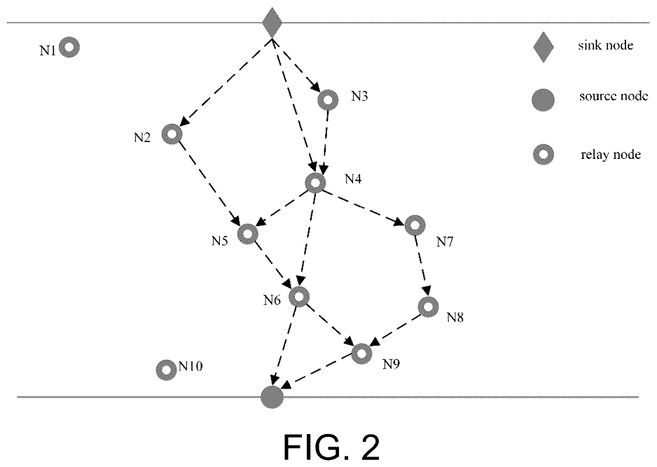

FIG. 2 shows a process of implementing routing establishment in the present disclosure. In the figure, a sink node first broadcasts a beacon packet at a maximum transmission power, a node that receives the beacon packet (such as, N2, N3, or N4) calculates a power level required from the node to the sink node by measuring a received signal strength, then calculates a forwarding factor from the node to the sink node according to information in the packet and the power level, and stores the same to a routing table; and finally, the node will update the information in the beacon packet and broadcasts at a maximum transmission power, and this process continues until a source node receives the beacon packet. A node that does not receive a beacon packet (such as N1 or N11) will not participate in communication, as it does not have a suitable next-hop node.

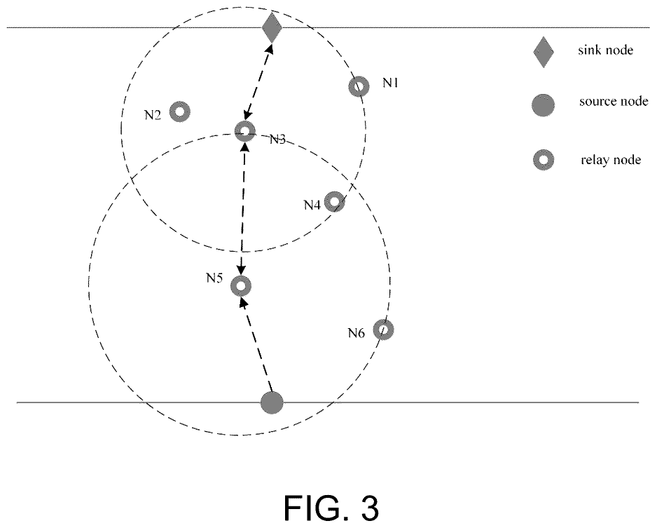

FIG. 3 shows a process of implementing data forwarding in the present disclosure. The source node sends a data packet and sets the next hop as a node named N5 according to the routing table; after receiving the data packet, N5 only forwards the data packet and then stores the same in a packet queue, without sending an ACK packet to the source node; since a power level of N5 when forwarding the data packet is greater than that of the source node sending the data packet, the source node can directly monitor the data packet forwarded by N5, thereby confirming that the data packet has been successfully forwarded, and the information of N5 in the routing table is updated at the same time. When forwarding the data packet, N3 needs to send an ACK packet to N5, since a power level of N3 when forwarding the data packet is relatively small, N5 cannot monitor the data packet forwarded by N3; moreover, the sink node does not forward the data packet underwater, it is also necessary to send an ACK packet. In the figure, N4 will receive the data packet forwarded by N5 but will discard the same, because it can determine that the data packet is not a target node, and at the same time, N4 will also receive the data packet and ACK packet sent from N3, and will update the routing table according to the information in the packet and signal strength.

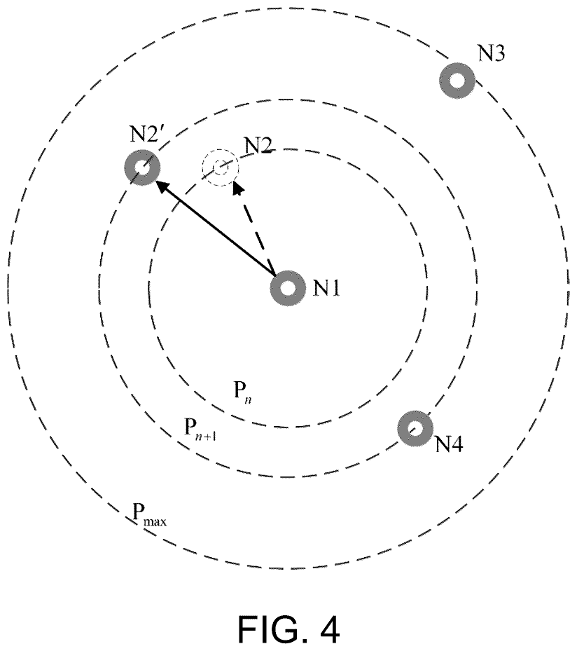

FIG. 4 shows a process of implementing local recovery in the present disclosure. N1 forwards a data packet to N2 at a power level Pₙ, but N2 has moved out of a communication range of the power level Pₙ at the moment, resulting in a failed forwarding. Therefore, N1 triggers a local recovery mechanism and sends a probe packet at the maximum transmission power. Nodes N2, N3, and N4 all receive the probe packet, among which N4 has a depth greater than that of N1, therefore, N4 will not send a probe response packet to N1, however, N4 will update its own routing table according to information of the probe packet; and N2 and N3 will both send a probe response packet to N1, and N1 will update the routing table accordingly, and resend a data packet.

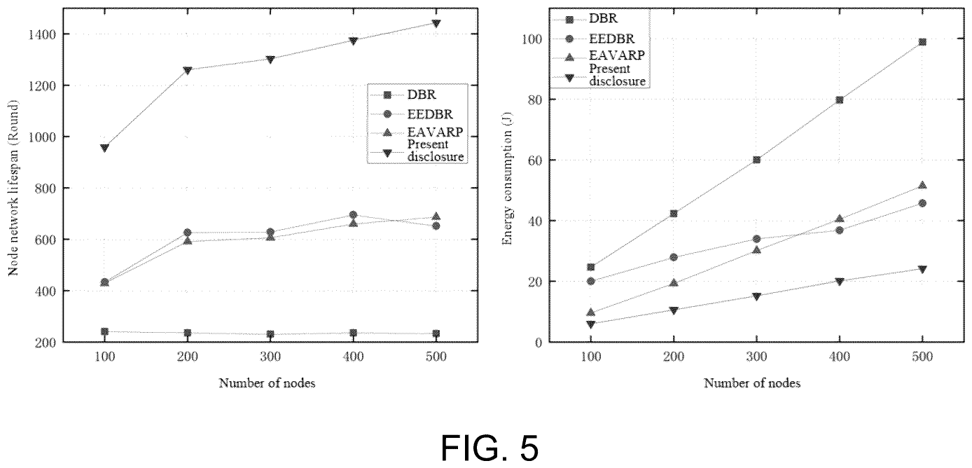

FIG. 5 shows a comparison diagram of network lives between the routing method in the present disclosure and other routing methods. In the figure, simulation is performed for different numbers of nodes and different movement speeds of nodes. Simulation results indicate that the present disclosure is superior to other methods in reducing network energy consumption and extending network life cycle.

The energy saving and efficient routing method for an underwater sensor network provided in the present disclosure includes the following three parts:
a. Data forwarding algorithm: during a data forwarding phase, a node traverses a neighbor list, sets a neighbor node with a maximum forwarding factor as an optimal next-hop node, and forwards data to the node. Since it takes some time for the node to confirm whether the data packet has been successfully sent after the data packet is sent out, each node will maintain a to-be-confirmed packet queue (Q). When sending a data packet, the node will set a timer (T), and store the sent packet in the Q at the same time; when it is monitored that the next-hop node forwards the data packet or receives the ACK packet responded by the next-hop node before the T expires, it means that the packet is sent successfully, the node will delete the data packet from the Q, otherwise, the data packet is not sent successfully, in which case, it is necessary to execute the local recovery mechanism.
b. Implicit routing update algorithm: Unlike a traditional update mechanism that updates a routing table by sending a control packet, an implicit routing update mechanism emphasizes completing a routing update process while communicating between nodes (such as sending the data packet or other control packets).
c. Data protection and network recovery mechanism: data packet forwarding may be interrupted due to the mobility of nodes. To address the problem, an integrated strategy of local-overall combination is adopted to ensure the network communication effects.

For the data forwarding algorithm, a forwarding factor is adopted to determine the optimal next-hop node, assuming that Node A is a data forwarding node, and Node B is a next-hop node of Node A, the forwarding factor f_{AB} of Node B relative to Node A is calculated as follows:

$$\begin{matrix}{f}_{AB} = {p}_{B} ( α {E}_{η AB} + β {E}_{re} ) & {E}_{re} , {E}_{η AB} ∈\end{matrix} ( 0 , 1 ]$$

where p_{B} is a forwarding success rate of a data packet of Node B, with an initial value of 1; α and β are system parameters, meeting α+β8=1, in theory, the larger α is, the better the routing effects become in energy saving; and on the contrary, the smaller α is, normalized energy efficiency between Node A and Node B of the routing becomes better. Eᵣₑ and E_{ηAB} are normalized residual energy efficiency of Node A and normalized energy efficiency between Node A and Node B, respectively.

The implicit routing update algorithm emphasizes completing a routing update process while communicating between nodes (such as sending the data packet or other control packets). When the data packet or the control packet is monitored, the node first measures the signal strength of the packet and reads the information in the packet, then traverses the neighbor list; when a node of the sending packet is in the neighbor node, information of the node will be updated; when the node of the sending packet is not in the neighbor list, it is determined whether the node meets the conditions for becoming the next-hop node, information of the sending node will be included into the neighbor list when the conditions are met, otherwise, the routing table will not be updated.

The data protection and network recovery mechanism includes the integrated strategy of local-overall combination designed by the present disclosure, specifically including two parallel mechanism, that is, a local recovery mechanism and an overall recovery mechanism. When the data packet forwarding fails, the local recovery mechanism will be triggered, the node will send a probe packet to rebuild a routing table, and retransmit the data according to the routing table. When the sink node monitors a drop in the packet arrival rate, the local recovery mechanism will be triggered, and the sink node will send a beacon packet to complete the routing reconstruction of the entire network.

The present disclosure provides an energy-balanced and efficient routing method that adopts a power control mechanism to reduce energy consumption. The present disclosure includes two phases: that is, routing establishment phase and data forwarding phase. In the routing establishment phase, a sink node broadcasts a beacon packet at the maximum transmission power to establish an initial path, and a receiving node updates the routing table according to beacon information and forwards the beacon packet. In the data forwarding phase, the present disclosure provides a new forwarding factor, which gives comprehensive consideration to energy efficiency and energy balance, selects a node with high energy efficiency and sufficient energy an optimal next-hop node, thereby extending the life cycle of the network. The present disclosure further provides a data protection and network recovery mechanism to address problems such as topological changes of the network and data forwarding failures caused by node movement. Compared with other typical routing methods, the present disclosure has superior performance in reducing network energy consumption and extending network life cycle.

Although the embodiments of the present disclosure have been described in conjunction with the accompanying drawings, those skilled in the art may make various modifications and variations without departing from the spirit and scope of the present disclosure, and such modifications and variations fall within the scope defined by the appended claims.

What is claimed is:

1. An energy saving and efficient routing method for an underwater sensor network, comprising the following steps:
step 1: broadcasting, by a sink node on a water surface, a beacon packet at a maximum transmission power to perform routing establishment;
step 2: entering, by a network, a data forwarding phase upon completion of the routing establishment; when receiving a data packet by a relay node, first executing an implicit routing update mechanism by the relay node, updating a routing table according to information in the data packet by the relay node, and then forwarding the data packet to a neighbor node with a maximum forwarding factor by the relay node; and
step 3: when the sink node receives the data packet, which indicates that data forwarding is successful, then filtering out a duplicate packet and calculating a packet arrival rate by the sink node; and when the packet arrival rate is lower than a threshold, triggering an overall recovery mechanism is triggered, and rebuilding a network routing by the sink node.

2. The energy saving and efficient routing method for an underwater sensor network according to claim 1, wherein when the data packet forwarding fails, the following steps are continuously performed:
step 4: after a node forwards the data, neither a next-hop node forwarding the data packet is monitored nor an ACK packet from the next-hop node is received in a period of time (T), determining that the data forwarding fails, in which case, the node needs to executes a local recovery mechanism; and
step 5: when the local recovery mechanism fails to rebuild the network routing, determining the node to be a void node, and broadcasting a void notification packet by the node to notify a previous-hop node to remove itself from a neighbor list.

3. The energy saving and efficient routing method for an underwater sensor network according to claim 1, wherein in a routing establishment phase, the sink node broadcasts the beacon packet at the maximum transmission power to establish an initial path; when receiving the beacon packet from the previous-hop node, the relay node calculates a power level required for the previous-hop node by measuring a received signal strength, then calculates a forwarding factor for the previous-hop node according to information in the packet and the power level, and stores the same to the routing table, and finally the relay node will update the information in the beacon packet and broadcast at the maximum transmission power.

4. The energy saving and efficient routing method for an underwater sensor network according to claim 1, wherein the implicit routing update mechanism involves the node monitoring all data packets and control packets within a communication range thereof, and completing the updating and maintenance of the network routing according to the signal strength and information in the packet.

5. The energy saving and efficient routing method for an underwater sensor network according to claim 4, wherein the implicit routing update mechanism involves monitoring the data packets and the control packets, in which case, the node first measures signal strengths of the packets and reads the information in the packets, then traverses the neighbor list; when a node of a sending packet falls within the neighbor list, information of the node will be updated; when the node of the sending packet falls out of the neighbor list, it is determined whether the node meets the conditions for becoming the next-hop node, information of the sending node will be included into the neighbor list when the conditions are met, otherwise, the routing table will not be updated.

6. The energy saving and efficient routing method for an underwater sensor network according to claim 1, wherein the forwarding factor is as follows: assuming that Node A is a data forwarding node, and Node B is a next-hop node of Node A, the forwarding factor f_{AB} of Node B relative to Node A is calculated as follows:
$$\begin{matrix}{f}_{AB} = {p}_{B} ( α {E}_{η AB} + β {E}_{re} ) & {E}_{re} , {E}_{η AB} ∈\end{matrix} ( 0 , 1 ]$$
in the formula, P_{B} is a forwarding success rate of a data packet of Node B, with an initial value of 1; α and β are an energy efficiency weight and a residual energy weight, respectively, meeting α+β=1; and Eᵣₑ and E_{ηAB} are normalized residual energy efficiency of Node A and normalized energy efficiency between Node A and Node B, respectively.

7. The energy saving and efficient routing method for an underwater sensor network according to claim 1, wherein when a depth difference between the node and the neighbor node is greater than a depth difference threshold, the node will calculate the forwarding factor between the node and the neighbor node, and store the same in the neighbor list; and the depth difference threshold dₜₕ is calculated according to the following formula:
$${d}_{th} = γ R$$
in the formula, R is a maximum communication radius, and γ is a threshold coefficient, with a value range of (0,1].

8. The energy saving and efficient routing method for an underwater sensor network according to claim 1, wherein since the node takes some time to confirm whether the data packet has been successfully sent after the data packet is sent out, each node will maintain a to-be-confirmed packet queue (Q); when sending a data packet, the node will set a timer (T), and store the sent packet in the Q at the same time; when the node monitored that the next-hop node forwards the data packet or receives the ACK packet responded by the next-hop node before the T expires, which means that the data packet is sent successfully, the node will delete the data packet from the Q, otherwise, the data packet is not sent successfully, in which case, the local recovery mechanism is executed.

9. The energy saving and efficient routing method for an underwater sensor network according to claim 1, wherein the local recovery mechanism involves sending a probe packet at the maximum transmission power and setting waiting time (T) by the node when the sending fails; after receiving the probe packet, a next-hop node that meets the next-hop node conditions responds with a probe response packet at the maximum transmission power; upon reception of the probe response packet, the node will calculate the forwarding factor and update the routing table; and after the waiting time (T) expires, the node will select the neighbor node with the maximum forwarding factor in the routing table as the next-hop node and forward the data packet.

10. The energy saving and efficient routing method for an underwater sensor network according to claim 1, wherein the global recovery mechanism involves sharing the received data packets by all the sink nodes, recording a total number of non-duplicate packets received within the T, and comparing the value with a total number of data packets sent by a source node within the same period of time; and when a ratio thereof is less than a preset threshold, the overall recovery mechanism will be triggered, and the sink node will send a beacon packet to complete the rebuilding of an overall network routing.
